(19) United States
(12) Patent Application Publication
(10) Pub. No.: US 2008/0228343 A1
(43) Pub. Date: Sep. 18, 2008

(54) Change Time Notifying Device for Notifying Change Time of a Consumable

(75) Inventor: Akihiro YOSHIZAWA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/049,157

(22) Filed: Mar. 14, 2008

(30) Foreign Application Priority Data
Mar. 14, 2007 (JP) 2007-065291

(51) Int. Cl. G06F 19/00

(52) U.S. Cl. 701/30

(57) ABSTRACT

A change time notifying device for notifying a change time of a consumable used on a vehicle. A control device counts a mileage accumulated from the last change of engine oil that must be changed according to the mileage of a vehicle as a mileage after the change. A change time notification processing section notifies a rider when a change time of the engine oil has come. A mileage display section displays mileage information based on the mileage after the change.

### RELATED APPLICATIONS

This application claims the benefit of priority under 35 USC 119 of Japanese patent application no. 2007-065291, filed on Mar. 14, 2007, which application is hereby incorporated by reference in its entirety.

### BACKGROUND OF THE INVENTION

1. Field of the Invention

This invention relates to a change time notifying device for notifying a change time of a consumable that must be changed according to a mileage of a vehicle.

2. Description of Related Art

A straddle-type vehicle such as a motorcycle uses consumables such as engine oil and a belt for transmitting driving force of an engine to a rear wheel(s) that must be changed according to a mileage of a vehicle, are used. A conventional change time notifying device advises the rider that the change time has come or is near by lighting up an indicator lamp and the like on an instrument panel (see JP-A-2005-153682, for example).

However, this change time notifying device does not provide sufficient convenience. For example, a rider may want to change a consumable before the indicator lamp lights up before traveling a long distance. However, the rider cannot forecast the change time with the above change time notifying device and thus cannot determine whether or not to make the change before the long distance trip.

### SUMMARY OF THE INVENTION

This invention addresses these problems and improves convenience in a change time notifying device for notifying a change time of a consumable that must be changed according to a mileage of a vehicle.

A change time notifying device according to the present invention includes a counting device for counting a mileage accumulated from a last change of a consumable that is changed according to the mileage of a vehicle as a mileage after the change. A display device has a change time arrival display section for notifying a rider when the change time of the consumable has come and displays mileage information based on the mileage after the change.

According to the present invention, the mileage information based on the mileage after the change is displayed. This allows the rider to forecast the change time, thereby improving convenience of the change time notifying device. The mileage information may be, for example, the mileage after the change or an index determined according to the mileage after the change.

In one embodiment, the display device includes a display section for displaying vehicle information related to the vehicle other than the mileage information and displays on the display section the mileage information by switching from the vehicle information. According to this aspect, an exclusive display section for displaying the mileage information is unnecessary, and therefore the display device is simplified.

In one embodiment, the display device notifies the rider when the mileage information is displayed on the display section. This allows the rider to know that mileage information is displayed on the display section, thereby improving convenience of the change time notifying device. Further, the display device may notify the rider when mileage information is displayed on the display section using the change time arrival display section. This allows omission of an exclusive display section for notifying the rider that the mileage information is being displayed. Therefore, the display device is simplified. Further, when the mileage information is displayed on the display section, the display mode of the change time arrival display section may be different from that when the change time of the consumable has come.

Further, in one embodiment, an input device for instructing the counting device to restart counting the mileage after the change is provided.

Further, in one embodiment, the counting device counts a mileage accumulated from the last change of a second consumable that is changed according to the mileage of the vehicle and different from the consumable as a second mileage after the change. Change times for multiple consumables can thereby be notified.

Further, in one embodiment, the display device has a display section for displaying the mileage information and may display on the display section second mileage information based on the second mileage after the change by switching from the mileage information. Thus, an exclusive display section for displaying the second mileage information is unnecessary, and the display device is therefore simplified. Further, the display device notifies the rider when the second mileage information is displayed on the display section, and the display device includes a second change time arrival display section for notifying the rider when the change time of the second consumable has come. This allows omission of an exclusive display section for notifying the rider that the second mileage information is displayed. Therefore, the display device is simplified.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a side view of a motorcycle provided with an exemplary change time notifying device as an embodiment of the present invention.

FIG. 2 is a block diagram of the change time notifying device.

FIG. 3 is a front view of a display panel for a display device of the change time notifying device.

FIG. 4 is a functional block diagram of a control device provided with the change time notifying device.

FIG. 5 is a flowchart of processing executed by a display control section of the control device.

FIGS. 6(a)-6(d) are diagrams showing mileage information displayed on the mileage display section.

FIG. 7 is a flowchart of processing executed by a change time notification processing section of the control device.

FIG. 8 is a flowchart of processing executed by a counting restart processing section of the control device.

FIG. 9 is another diagram showing information displayed on the mileage display section.

### DETAILED DESCRIPTION OF THE INVENTION

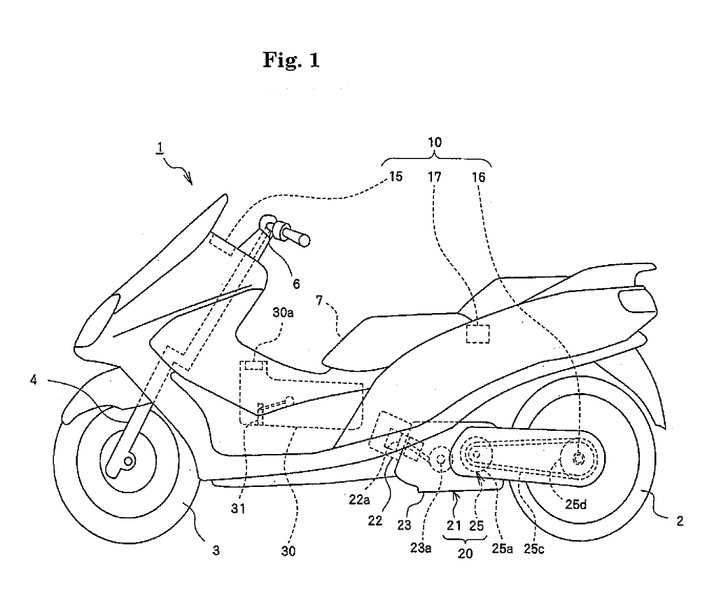

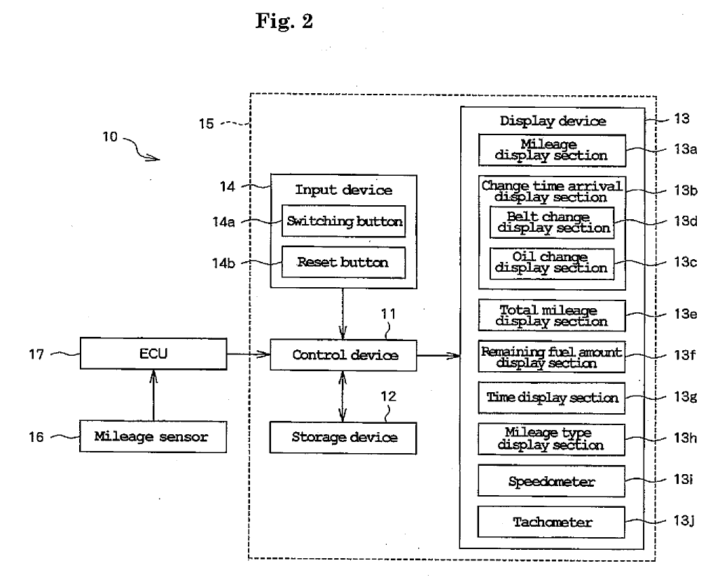

An embodiment of the present invention is now described with reference to the drawings. FIG. 1 is a side view of a motorcycle 1 having a change time notifying device 10 as an example of an embodiment of the present invention. FIG. 2 is a block diagram of change time notifying device 10.

As shown in FIG. 1, motorcycle 1 also includes an engine unit 20 and a fuel tank 30. As shown in FIG. 2, change time notifying device 10 includes a display unit 15, a mileage sensor 16 and an engine control unit (ECU) 17. Display unit 15 includes a control device 11, a storage device 12, a display device 13 and an input device 14.

In this example, engine unit 20 is a unit swing type disposed along with a rear wheel 2 for up and down swingable movement. As shown in FIG. 1, engine unit 20 includes an engine 21 and a driving force transmission mechanism 25. Engine 21 includes a cylinder block 22 disposed at a front part thereof and a crankcase 23 disposed behind cylinder block 22.

At least one cylinder is formed within cylinder block 22. A piston 22a is disposed in the cylinder. Piston 22a reciprocates to generate driving force. The driving force is transmitted to driving force transmission mechanism 25 via a crankshaft 23a disposed in crankcase 23. Engine oil is stored in crankcase 23. The engine oil is scooped up by a movable member (a gear, for example) operated by driving force generated by reciprocation of piston 22a and lubricates movable members inside engine 21. Engine 21 is provided with an outlet for discharging engine oil and an inlet for feeding engine oil into engine 21. When engine oil is changed, a user discharges old engine oil through the outlet and then feeds new engine oil through the inlet.

Driving force transmission mechanism 25 is, for example, a belt type continuously variable transmission having a driving sheave 25a to which driving force of engine 21 is inputted, a driven sheave 25b rotating together with rear wheel 2, and a belt 25c around driving sheave 25a and driven sheave 25b for transmitting driving force from driving sheave 25a to driven sheave 25b. A radius of the portion of belt 25c around driving sheave 25a and a radius of the portion of belt 25c around driven sheave 25b vary in response to the rotational speed of rear wheel 2. This allows the reduction ratio to vary continuously.

Fuel tank 30 is disposed forward of engine unit 20. A fuel inlet 30a is disposed in the upper part of fuel tank 30. A liquid level sensor 31 for detecting the remaining amount of fuel is disposed inside fuel tank 30. Liquid level sensor 31 is, for example, a float-type sensor, which has a float attached to an end of an arm floating on the fuel surface and a variable resistor disposed at the bottom of the arm. The resistance of the resistor varies according to the tilt angle of the arm. Control device 11 detects the remaining amount of fuel based on a current or a voltage applied on the variable resistor and lights up a remaining fuel amount display section 13f based on the remaining amount of fuel.

A seat 7 is disposed above engine unit 20. ECU 17 is disposed between seat 7 and engine unit 20 and is supported, for example, by a body frame.

A front wheel 3 is rotationally supported by a front fork 4 that extends obliquely in a vertical direction. A handlebar 6 extending in a vehicle width direction is connected to the top of front fork 4. Display unit 15 is disposed forward of handlebar 6.

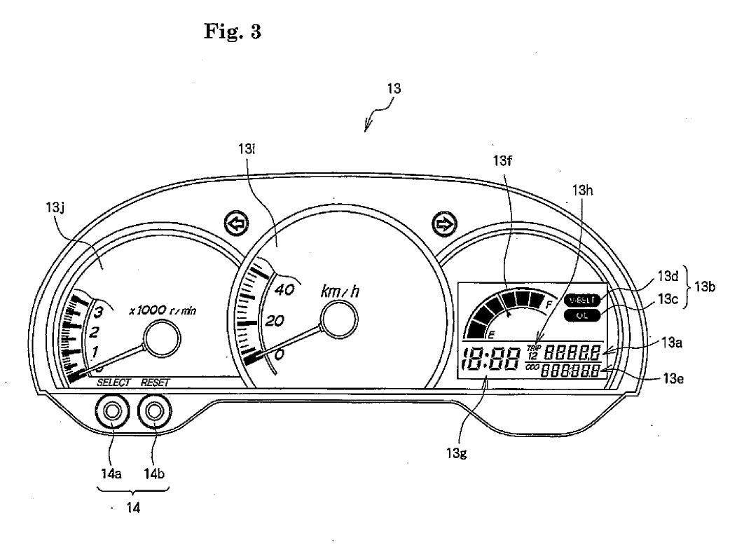

Display device 13 included in display unit 15 has a speedometer for displaying vehicle speed, a tachometer for displaying engine speed and the like. Display device 13 also has a mileage display section 13a (see FIG. 3) for displaying a mileage of motorcycle 1. Input device 14 for the rider to input a signal to control device 11 is provided on the near side (seat 7 side) of display device 13. Input device 14 is used for switching the type of mileage displayed on mileage display section 13a.

The configuration of change time notifying device 10 is now described. As described above, change time notifying device 10 has control device 11, storage device 12, display device 13, input device 14, mileage sensor 16 and ECU 17.

Display device 13 displays various information relating to motorcycle 1 according to signals inputted from control device 11. FIG. 3 illustrates an example of the display panel for display device 13. Display device 13 includes mileage display section 13a, a change time arrival display section 13b, a total mileage display section 13e, remaining fuel amount display section 13f, a time display section 13g, a mileage type display section 13h, a speedometer 13i and a tachometer 13j.

Mileage information (“change notifying mileage information”) based on the mileage after the last change (“mileage after the change”) of a consumable that must be changed according to the mileage of motorcycle 1, and vehicle information relating to motorcycle 1 that is different from the change notifying mileage information are displayed on mileage display section 13a. The change notifying mileage information is displayed by switching from vehicle information according to the signal inputted from control device 11 to display device 13.

Consumables that must be changed according to mileage are, for example, belt 25c provided in driving force transmission mechanism 25 and engine oil stored inside engine 21. The change notifying mileage information is, for example, the mileage after the change or a remaining mileage (the difference between a change requiring mileage and the mileage after the change) up to a certain mileage (“change requiring mileage”) at which the consumable should be changed. The change requiring mileage may be, for example, several thousand kilometers. The change notifying mileage information may also be an evaluation result (for example, “2” in a five-step evaluation) in which the mileage after the change is evaluated in multiple steps (five steps, for example). In the example described here, the change notifying mileage information related to belt 25c (“belt related mileage information”) and the change notifying mileage information related to engine oil (“oil related mileage information”) are displayed on mileage display section 13a. The vehicle information that is different from the change notifying mileage information is, for example, a mileage (“trip mileage”) from any point appointed by the rider. In the example described here, two different trip mileages from two different points (“first trip mileage” and “second trip mileage”) are counted.

Change time arrival display section 13b advises a rider when control device 11 determines that the change time of the consumable has come. When change notifying mileage information is displayed on mileage display section 13a, change time arrival display section 13b has a display mode that is different from that when the change time of the consumable has come. In this way, change time arrival display section 13b advises the rider that change notifying mileage information is displayed on mileage display section 13a.

In this example as shown in FIG. 3, change time arrival display section 13b includes an oil change display section 13c for notifying the arrival of the change time of the engine oil and a belt change display section 13d for notifying the arrival of the change time of belt 25c. In oil change display section 13c, some predetermined characters (“OIL”, in this example) are displayed. Also, in belt change display section 13d, other predetermined characters (“V-BELT”, in this example) are displayed.

Total mileage display section 13e displays a total mileage of motorcycle 1. Remaining fuel amount display section 13f displays the remaining amount of fuel based on a signal inputted from liquid level sensor 31. In this example, remaining fuel amount display section 13f is divided into multiple (six in this example) areas in an arc shape and the area corresponding to the remaining amount of fuel lights up. Time display section 13g displays a present time. Mileage type display section 13h notifies the rider of a trip mileage type displayed on mileage display section 13a. For example, when a first trip mileage is displayed on mileage display section 13a, some predetermined characters (“TRIP1”, in this example) are displayed. And when a second trip mileage is displayed, other predetermined characters (“TRIP2”, in this example) are displayed. In this example, speedometer 13i is an analog type speedometer and notifies the rider of the speed by turning a pointer by an angle corresponding to vehicle speed. In this example, tachometer 13j is an analog type tachometer and notifies the rider of the engine speed by turning a pointer by an angle corresponding to the engine speed.

Input device 14 is operated by the rider to input a signal to control device 11. In this example, input device 14 includes a switching button 14a for switching the mileage information displayed on mileage display section 13a, and a reset button 14b for restarting counting the trip mileage or the mileage after the change. As shown in FIG. 3, switching button 14a and reset button 14b may be disposed in the lower portion of display device 13.

Control device 11 includes, for example, a central processing unit (CPU) and executes a program stored in storage device 12 to control change time notifying device 10. Control device 11 counts the mileage (the mileage after the change, first trip mileage, and second trip mileage in this example) of motorcycle 1 based on a signal outputted by mileage sensor 16 and executes a process to display on display device 13 information based on the mileage.

Storage device 12 includes a random access memory (RAM) and a read only memory (ROM) and stores in advance a program to be executed by control device 11. Storage device 12 also stores the mileage counted by control device 11. The mileage stored by storage device 12 is successively revised by control device 11 when motorcycle 1 is driven.

Mileage sensor 16 is a sensor for calculating the mileage of motorcycle 1 and, for example, may be a vehicle speed sensor that outputs a pulse signal with a frequency according to the rotational speed of the rotary axis of rear wheel 2. Control device 11 counts the pulse signal to calculate the mileage. ECU 17 controls the ignition timing of engine 21 and the amount of fuel supplied to engine 21. The pulse signal outputted from mileage sensor 16 is inputted to ECU 17 and then to control device 11.

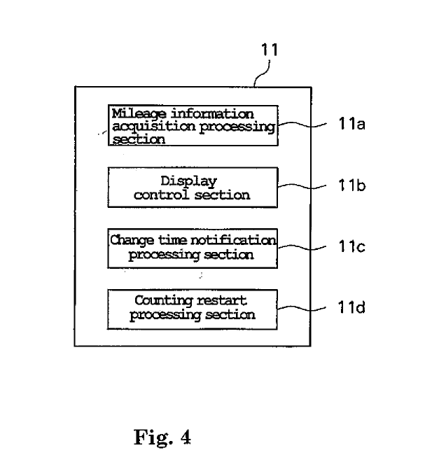

The process executed by control device 11 is now described. FIG. 4 is a functional block diagram of control device 11. As shown in FIG. 4, control device 11 functionally includes a mileage information acquisition processing section 11a, a display control section 11b, a change time notification processing section 11c and a counting restart processing section 11d.

Based on the signal outputted by mileage sensor 16, mileage information acquisition processing section 11a acquires mileage information, which is in turn displayed on mileage display section 13a. Specifically, based on the signal outputted by mileage sensor 16, mileage information acquisition processing section 11a calculates the mileage after the change, or the mileage after the last change of the consumable that must be changed according to the mileage. Then, mileage information acquisition processing section 11a acquires the aforementioned change notifying mileage information based on the mileage after the change.

As described above, the consumables may include belt 25c and the engine oil. Mileage information acquisition processing section 11a calculates the mileage accumulated from the last change of belt 25c (“mileage after the belt change”) and the mileage accumulated from the last change of the engine oil (“mileage after the oil change”). Mileage information acquisition processing section 11a then acquires belt related mileage information based on the mileage after the belt change and oil related mileage information based on the mileage after the oil change. The process for acquiring mileage information by mileage information acquisition processing section 11a is executed as follows.

Mileage information acquisition processing section 11a accumulates the mileage after the oil change and the mileage after the belt change each time the pulse signal of mileage sensor 16 is inputted while motorcycle 1 is driven. Mileage information acquisition processing section 11a defines, for example, the mileage after the oil change and the mileage after the belt change acquired by accumulation as the oil related mileage information and the belt related mileage information. Also, mileage information acquisition processing section 11a may calculate the difference between a mileage at which belt 25c should be changed (“belt change requiring mileage”) and the mileage after the belt change and define the difference as the belt related mileage information. Likewise, mileage information acquisition processing section 11a may calculate the difference between a mileage at which the engine oil should be changed (“oil change requiring mileage”) and the mileage after the oil change and define the difference as the oil related mileage information. The belt change requiring mileage and the oil change requiring mileage are predetermined, for example, in the manufacturing stage of motorcycle 1 and stored in storage device 12.

Alternatively, mileage information acquisition processing section 11a may define an index given according to the calculated mileage after the oil change and the calculated mileage after the belt change as the oil related mileage information and the belt related mileage information. For example, mileage information acquisition processing section 11a may evaluate the mileage after the oil change and the mileage after the belt change and define the evaluation result as the oil related mileage information and the belt related mileage information, respectively. As a concrete example, the oil change requiring mileage may be set to 5000 kilometers and the mileage after the oil change may be evaluated in 5 steps. For example, the evaluation result from 0-1000 kilometers is set to 1 and the evaluation result from 1001-2000 kilometers is set to 2. In the same way, the mileage from 0-5000 kilometers is divided into 5 steps. Thus, the oil change requiring mileage is divided into 5 steps. When the mileage after the oil change is 1400 kilometers, the an evaluation result of 2 is defined as the oil related mileage information.

The mileage after the oil change and the mileage after the belt change are set to initial values (zero, for example) by counting restart processing section 11d when the engine oil or belt 25c is changed. When the mileage after the oil change and the mileage after the belt change are set to initial values, mileage information acquisition processing section 11a restarts to accumulate mileage from the initial value. Mileage information acquisition processing section 11a successively revises the mileage after the oil change and the mileage after the belt change stored in storage device 12 with an acquired value by the accumulation.

Mileage information acquisition processing section 11a accumulates the total mileage, first trip mileage and second trip mileage based on the signal outputted by mileage sensor 16 in addition to the mileage after the oil change and the mileage after the belt change. The first and second trip mileages are displayed on mileage display section 13a as first trip mileage information and second trip mileage information. The total mileage is displayed on total mileage display section 13e as total mileage information. Mileage information acquisition processing section 11a successively revises information of the mileage stored in storage device 12 while motorcycle 1 is driven.

Display control section 11b executes a process of displaying on mileage display section 13a mileage information calculated by mileage information acquisition processing section 11a according to instruction of the rider. Specifically, display control section 11b switches the mileage information displayed on mileage display section 13a, according to a rider's instruction, among belt related mileage information, oil related mileage information, first trip mileage information, and second trip mileage information. For example, when a signal instructing to switch the mileage information is inputted by rider operation of switching button 14a, display control section 11b may switch the mileage information displayed on mileage display section 13a from second trip mileage information to oil related mileage information.

Display control section 11b lights up mileage type display section 13h in accordance with the trip mileage information displayed on mileage display section 13a. Specifically, when first trip mileage information is displayed on mileage display section 13a, display control section 11b instructs mileage type display section 13h to display “TRIP1.” When second trip mileage information is displayed on mileage display section 13a, display control section 11b instructs mileage type display section 13h to display “TRIP2.”

When change time notification processing section 11c determines that the change time of the consumable has come, change time notification processing section 11c executes a process of notifying the rider of the change time. Specifically, change time notification processing section 11c determines whether or not the mileage of motorcycle 1 has reached the belt change requiring mileage based on the mileage after the belt change calculated by mileage information acquisition processing section 11a. When the mileage has reached the belt change requiring mileage, change time notification processing section 11c lights up belt change display section 13d in a predetermined mode (“change time notification mode”). For example, change time notification processing section 11c intermittently lights up (flashes) belt change display section 13d or increases luminance higher than the predetermined value. Likewise, change time notification processing section 11c determines whether or not the mileage of motorcycle 1 has reached the oil change requiring mileage based on the mileage after the oil change. When the mileage has reached the oil change requiring mileage, change time notification processing section 11c lights up oil change display section 13c in the change time notification mode.

When the change notifying mileage information (the belt related mileage information or the oil related mileage information in the above description) is displayed on mileage display section 13a, change time notification processing section 11c notifies the rider of the change time using change time arrival display section 13b. This process is executed as follows, for example.

Change time notification processing section 11c monitors whether or not belt related mileage information or oil related mileage information is displayed on mileage display section 13a, when change time notifying device 10 is operated. When belt related mileage information is displayed, change time notification processing section 11c lights up belt change display section 13d in a mode (“display type notification mode”) different than the mode employed when the mileage of motorcycle 1 has reached the belt change requiring mileage. For example, while belt related mileage information is displayed, change time notification processing section 11c invariably lights up belt change display section 13d. Alternatively, change time notification processing section 11c may light up belt change display section 13d at a lower luminance than at the time when the mileage has reached the belt change requiring mileage. Likewise, when oil related mileage information is displayed, change time notification processing section 11c lights up oil change display section 13c in the display type notification mode.

When the mileage after the belt change has reached the belt change requiring mileage and belt related mileage information is displayed on mileage display section 13a, change time notification processing section 11c may prioritize the change time notification mode over the display type notification mode in lighting. Likewise, when the mileage after the oil change has reached the oil change requiring mileage and oil related mileage information is displayed on mileage display section 13a, change time notification processing section 11c may prioritize the change time notification mode over the display type notification mode in lighting.

When the consumable is changed by the rider and a restart of counting the mileage after the change is instructed, counting restart processing section 11d executes a process of setting the mileage after the change stored in storage device 12 to the initial value. For example, when reset button 14b or switching button 14a is operated in a predetermined order after the engine oil is changed, the mileage after the oil change stored in storage device 12 is set to zero. Likewise, when the predetermined button operation is made after belt 25c is changed, the mileage after the belt change is also set to zero. After the mileage after the oil change or the mileage after the belt change is set to zero, mileage information acquisition processing section 11a restarts accumulation of these mileages from zero.

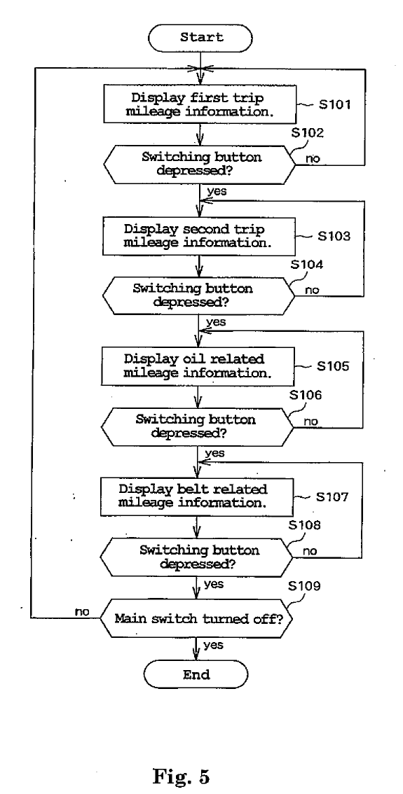

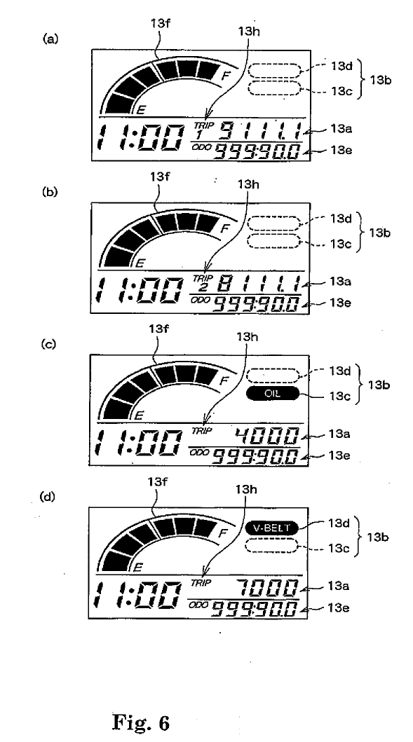

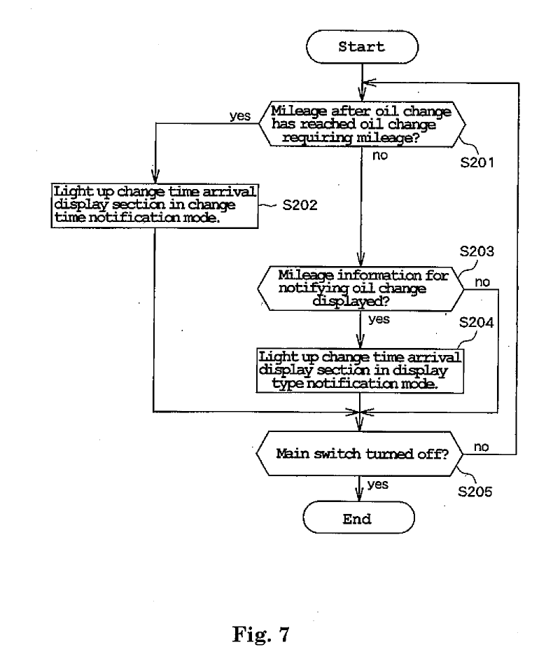

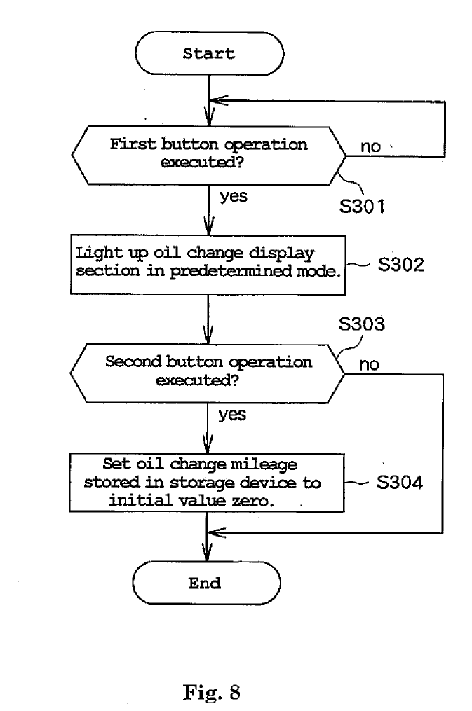

The flow of processing executed by control device 11 is now described. FIG. 5 is a flowchart of processing by display control section 11b. FIGS. 6(a)-(d) show examples of mileage information displayed according to the processing executed by display control section 11b. FIG. 7 is a flowchart of processing executed by change time notification processing section 11c. FIG. 8 is a flowchart of processing executed by counting restart processing section 11d.

The processing executed by display control section 11b is now described. Display control section 11b displays the first trip mileage information on mileage display section 13a (S101). Display control section 11b then determines whether or not switching button 14a is depressed by the rider (S102). Display control section 11b continues to display first trip mileage information until switching button 14a is depressed. FIG. 6(a) shows a state in which first trip mileage information is displayed on mileage display section 13a. At this time, display control section 11b displays a character string corresponding to the first trip mileage (“TRIP1”) on mileage type display section 13h.

When switching button 14a is depressed in S102, display control section 11b displays second trip mileage information on mileage display section 13a (S103). Display control section 11b then determines whether or not switching button 14a is depressed (S104). Display control section 11b continues to display second trip mileage information until switching button 14a is depressed. FIG. 6(b) shows a state in which second trip mileage information is displayed on mileage display section 13a. At this time, display control section 11b displays a character string corresponding to the second trip mileage (“TRIP2”) on mileage type display section 13h.

When switching button 14a is depressed in S104, display control section 11b displays oil related mileage information on mileage display section 13a (S105). FIG. 6(c) shows a state in which oil related mileage information is displayed on mileage display section 13a. At this time, oil change display section 13c lights up in the display type notification mode according to processing executed by change time notification processing section 11c. Display control section 11b then determines whether or not switching button 14a is depressed (S106). Display control section 11b continues to display oil related mileage information until switching button 14a is depressed.

When switching button 14a is depressed in S106, display control section 11b displays belt related mileage information on mileage display section 13a (S107). FIG. 6(d) shows a state in which belt related mileage information is displayed on mileage display section 13a. At this time, belt change display section 13d lights up in the display type notification mode according to processing executed by change time notification processing section 11c. Display control section 11b then determines whether or not switching button 14a is depressed (S108). Display control section 11b continues to display belt related mileage information until switching button 14a is depressed. When switching button 14a is depressed, display control section 11b determines whether or not the main switch of the vehicle is turned off (S109). If the main switch is not yet turned off, the process returns to S101 and following processes are executed again.

Even though oil related mileage information is displayed in S105, when the mileage after the oil change has reached the oil change requiring mileage, oil change display section 13c lights up not in the display type notification mode but in the change time notification mode according to processing executed by change time notification processing section 11c. Likewise, even though belt related mileage information is displayed in S107, when the mileage after the belt change has reached the belt change requiring mileage, belt change display section 13d lights up in the change time notification mode.

Exemplary processing executed by change time notification processing section 11c is now described with reference to FIG. 7. An example of control of oil change display section 13c by change time notification processing section 11c is described.

Change time notification processing section 11c first determines whether or not the mileage after the oil change accumulated by mileage information acquisition processing section 11a has reached the oil change requiring mileage (S201). If the mileage after the oil change has reached the oil change requiring mileage, change time notification processing section 11c lights up change time arrival display section 13b in the change time notification mode regardless of the oil related mileage information being displayed on mileage display section 13a (S202).

On the other hand, if the mileage after the oil change has not yet reached the oil change requiring mileage, change time notification processing section 11c determines whether or not oil related mileage information is displayed on mileage display section 13a (S203). If oil related mileage information is displayed, change time notification processing section 11c lights up change time arrival display section 13b in the display type notification mode (S204). If oil related mileage information is not displayed, change time notification processing section 11c determines whether or not the main switch of the vehicle is turned off (S205). If the main switch is not yet turned off, the process returns to S201 and subsequent processes are executed again. Change time notification processing section 11c repeats these processes when change time notifying device 10 is operated.

Processing executed by counting restart processing section 11d is now described with reference to FIG. 8. Exemplary processing for restarting the counting of the mileage after the oil change is described.

Counting restart processing section 11d first determines whether or not the rider executes a predetermined operation (“first button operation”) on switching button 14a or reset button 14b (S301). If the first button operation is not executed at this time, counting restart processing section 11d waits until the first button operation is executed. The first button operation means, for example, that reset button 14b is kept depressed for a predetermined time (a few seconds, for example) with oil related mileage information being displayed on mileage display section 13a.

When the first button operation is executed by the rider, counting restart processing section 11d lights up oil change display section 13c in a predetermined mode (S302). Counting restart processing section 11d then notifies the rider of restarting the process for setting a mileage after the oil change stored in storage device 12 to zero.

Then, counting restart processing section 11d determines whether or not the rider executes a predetermined operation (“second button operation”) on switching button 14a or reset button 14b (S303). The second button operation means, for example, that reset button 14b is kept depressed for a predetermined time (a few seconds, for example). This time may be same as the predetermined time for the first button operation or longer.

When the second button operation is executed in S303, counting restart processing section 11d sets the mileage after the oil change stored in storage device 12 to the initial value zero (S304). At this time, for example, the initial value zero is displayed on mileage display section 13a as oil related mileage information according to processing executed by display control section 11b. If the mileage after the oil change has reached the oil change requiring mileage and the oil change display section 13c is lighting up in the change time notification mode, the oil change display section 13c lights up in the display type notification mode by setting the mileage after the oil change to the initial value zero in S304.

On the other hand, if the second button operation is not executed within a predetermined time in S303, counting restart processing section 11d terminates the process without setting the oil change mileage to the initial value zero.

In change time notifying device 10 described above, oil related mileage information or belt related mileage information is displayed on mileage display section 13a. This allows the rider to forecast the change time of the engine oil or belt 25c, thereby improving convenience of the change time notifying device.

The present invention is not limited to the embodiment of change time notifying device 10 described above and can have various alternatives. For example, while oil related mileage information or belt related mileage information is described as displayed as a value on mileage display section 13a, this information may be displayed on remaining fuel amount display section 13f. Specifically, as described above, the mileage after the oil change or the mileage after the belt change may be evaluated in multiple steps by processing in mileage information acquisition processing section 11a and the evaluation result may be displayed on remaining fuel amount display section 13f.

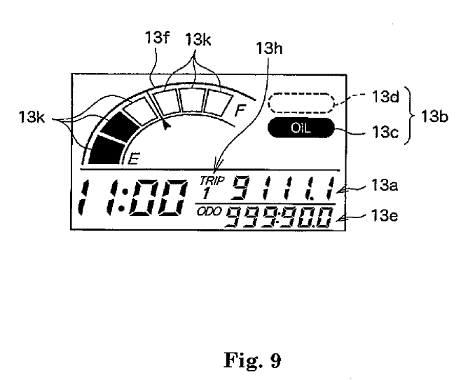

FIG. 9 illustrates an example of display device 13 in this alternative. In this example, the oil change requiring mileage is divided into 6 steps and the mileage after the oil change is evaluated at 2 in 6 steps. Display control section 11b shows the state that the mileage after the oil change is evaluated at 2 in 6 steps by lighting up the lower two of six area 13k's disposed in an arc shape in remaining fuel amount display section 13f. At this time, as shown in FIG. 9, change time notification processing section 11c may light up oil change display section 13c in order to show that oil related mileage information is displayed on remaining fuel amount display section 13f.

While particular embodiments of the invention have been described, it should be understood that these embodiments are exemplary, and not restrictive. Various modifications will be apparent to those of skill in the art and are within the scope of the present invention as set forth in the following claims.

1. A change time notifying device comprising:
a counting device for counting a mileage accumulated from a last change of a consumable that is changed according to the mileage of a vehicle as a mileage after the change; and
a display device that has a change time arrival display section for notifying a rider when the change time of the consumable has come and displays a mileage information based on the mileage after the change.

2. The change time notifying device according to claim 1, wherein the display device includes a display section for displaying vehicle information related to the vehicle other than the mileage information and displays on the display section the mileage information by switching from the vehicle information.

3. The change time notifying device according to claim 2, wherein the display device notifies the rider when the mileage information is displayed on the display section.

4. The change time notifying device according to claim 3, wherein the display device notifies the rider when the mileage information is displayed on the display section using the change time arrival display section.

5. The change time notifying device according to claim 4, wherein when the mileage information is displayed on the display section, the display mode of the change time arrival display section is different from that when the change time of the consumable has come.

6. The change time notifying device according to claim 1, further comprising an input device for instructing the counting device to restart counting the mileage after the change.

7. The change time notifying device according to claim 1, wherein the counting device counts a mileage accumulated from the last change of a second consumable that is changed according to the mileage of the vehicle and different from the consumable as a second mileage after the change.

8. The change time notifying device according to claim 6, wherein the display device includes a display section displaying the mileage information and displays on the display section a second mileage information based on the second mileage after the change by switching from the mileage information.

9. The change time notifying device according to claim 7, wherein the display device notifies the rider when the second mileage information is displayed on the display section, and the display device includes a second change time arrival display section for notifying the rider when a change time of the second consumable has come.

10. the change time notifying device according to claim 1, wherein the consumable is a belt or engine oil.

11. A vehicle comprising the change time notifying device according to claim 1.

12. A motorcycle comprising the change time notifying device according to claim 1.

13. A change time notifying method comprising:
counting a mileage accumulated from a last change of a consumable that is changed according to a mileage of a vehicle as a mileage after the change;
displaying mileage information based on the mileage after the change; and
notifying a rider when the change time of the consumable has come.
